(19) United States
(12) Patent Application Publication
(10) Pub. No.: US 2025/0358470 A1
(43) Pub. Date: Nov. 20, 2025

(54) VIDEO STORAGE OPTIMIZATION

(71) Applicants: Lemon Inc., Grand Cayman (KY); Beijing Zitiao Network Technology Co., Ltd., Beijing (CN)

(72) Inventors: Aoyang Zhang, Beijing (CN); Ruoyun Ma, Los Angeles, CA (US); Shenglan Huang, Culver City, CA (US); Binh NGUYEN, Culver City, CA (US); Qian Chen, Culver City, CA (US); Darui Wang, Beijing (CN); Mingkui Liu, Culver City, CA (US); Qian Ma, Beijing (CN)

(21) Appl. No.: 19/207,584

(22) Filed: May 14, 2025

Related U.S. Application Data
(63) Continuation of application No. PCT/CN2024/093181, filed on May 14, 2024.

(51) Int. Cl. H04N 21/4335; H04N 21/454

(52) U.S. Cl. CPC H04N 21/4335; H04N 21/454

(57) ABSTRACT

Methods, systems, and apparatus, including computer programs encoded on computer storage media, for video storage optimization. One of the methods includes obtaining data for a plurality of video files of a content delivery system, wherein the plurality of video files corresponds to a set of video ladders, each video ladder identifying a respective transcoding version of video content represented by a video file of the plurality of video file and having different parameters; for each video file, executing one or more respective storage strategies to compute one or more respective output video scores, wherein each storage strategy uses trained models to evaluate characteristics of the respective video file and estimate future viewing of the video file; and in response to evaluating the output video scores computed for each of the plurality of video files, determining one or more actions to reduce storage for the plurality of video files.

### CROSS-REFERENCE TO RELATED APPLICATIONS

This application is a continuation application of PCT Application No. PCT/CN2024/093181, filed on May 14, 2024. which is hereby incorporated by reference in its entirety.

### BACKGROUND

This specification relates to video storage.

Video content providers can transcode video content into a number of different versions with different transcoding parameters. Using a set of different versions, which can also be referred to as video ladders, allows for particular versions of the video content to be selected for streaming to individual user devices based on, for example, different network conditions or device requirements. Different versions of the video in the video ladder can correspond to different video resolutions, e.g., 1080p and 540p, and bitrates. Higher video resolutions typically require higher bandwidth network connections. Consequently, the selection of a particular video ladder can impact the end user's perceived video quality and playback performance depending on their network performance.

### SUMMARY

This specification describes technologies for optimizing the video storage requirements for a given video ladder. A video ladder refers to a set of video renditions or versions, each with different encoding parameters, e.g., bitrates and resolutions, that are created from a source video file. Thus, storing a video ladder for a given video requires multiple different versions of the same video to be stored. The technologies described in this specification generally involve determining actions to be performed with respect to video files stored at a content delivery system to reduce storage and maintain a set of different versions (ladders) for a video file that minimizes storage costs while also providing high quality viewing services tailored to different restrictions or requirements of user devices and network communications. For example, changes in video resolution can result in blurring or pixelation of the video. Video stalling, for example due to rebuffering, can cause pauses or freezes during playback. Therefore, the quality of video content that is streamed to individual user devices and respective user experience in watching a video at a particular bitrate may depend on the stored variety of different versions of the transcoded video content.

While a particular set of ladders may be generated for many different videos of the video content provider, e.g., default number of different versions, in practice not all versions may need to be stored for a particular video. In particular, machine learning techniques can be used to identify what set of video ladders for a video file are to be stored to optimize an expected utility of each video. The expected utility refers to a measure of computing resources and time needed for streaming video content provided by a content delivery platform and user experience in watching the video at a particular bitrate.

In general, one innovative aspect of the subject matter described in this specification can be embodied in methods that include the actions of obtaining data for a plurality of video files of a content delivery system, wherein the plurality of video files corresponds to a set of video ladders, each video ladder identifying a respective transcoding version of video content represented by a video file of the plurality of video file and having different parameters; for each video file of the plurality of video files, executing one or more respective storage strategies to compute one or more respective output video scores, wherein each storage strategy uses trained models to evaluate characteristics of the respective video file and estimate future viewing of the video file; and in response to evaluating the output video scores computed for each of the plurality of video files, determining one or more actions for one or more of the video files to reduce storage for the plurality of video files.

Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages. Selecting video ladders for each video to be provided in response to a received request can be based on considerations for an optimized utility that takes video complexity and user network conditions into account. Maintaining various ladders for a video file can improve the video delivery services of a content system, however, storage costs can be a significant expense.

In accordance with implementations of the present disclosure, an intelligent video lifecycle management system can be provided that can monitor video file storage at a content delivery system and support file management. The intelligent video lifecycle management system can integrate multiple strategies and unify obtained results to resolve conflicts and output a recommended solution for the maintenance of a set of video ladders associated with a video file at the content delivery system. The recommendation can be based on integration of multiple strategies and by being flexible in accommodating different sets of strategies for different video files (e.g., based on considerations for properties of the file such as category of the file, or file size).

Trained machine learning models can be used to determine an optimization of storage of existing content at a content delivery system so that an optimized set of video ladders can be maintained as stored for high volumes of videos with reduced computation expenditures as compared to other techniques. In addition, the determination of the optimization for the storage can reduce the high storage requirements associated with cases where each video corresponds to one or multiple different versions (video ladders). The system can select a most appropriate version (or ladder) from the maintained optimized set of ladders when providing a video to a particular user based on the current network conditions and rebuffering possibilities that reduces a likelihood of video stalls and rebuffering events.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example video processing pipeline.

FIG. 2 is a flow diagram of an example process for optimizing a video ladder storage.

FIG. 3 is a block diagram of an example storage strategy service.

FIG. 4 is a block diagram of an example optimization module implementing machine learning techniques for optimization of storage for video files associated with multiple different ladders.

FIG. 5 is a flow diagram of an example process for evaluation of performance of storage strategies.

FIG. 6 is a block diagram of an example computing system.

Like reference numbers and designations in the various drawings indicate like elements.

### DETAILED DESCRIPTION

Video content can have different degrees of complexity. Complexity for a given video can depend on multiple factors including, for example, motion, color, texture, and scene changes within the video content. Different levels of complexity can mean that, at the same bitrate, a more complex video may have a lower perceptual quality than a lower complexity video. Additionally, when switching between videos, for example as part of a video feed on a social media application, the complexity may vary from video to video, e.g., as a user scrolls through their video feed.

When providing video content for one or more videos to an end user device, the network conditions may not be static. For example, the network speed and stability can vary between users based on, for example, geographical location, network infrastructure, and device capabilities. Moreover, the network conditions for the same user can also change because the user may be moving, e.g., walking, driving, etc. Thus, the network conditions when viewing one video may change when the user moves to the next video in the video feed.

A video file can be transferred out of multiple ladders to adapt to playback needs of an end user device that may depend on various network conditions or video scene characteristics. Maintaining multiple ladders can provide better flexibility to the playback needs of end user devices and more efficiently use computational and network resources for the video content streaming. However, maintaining multiple video ladders for a video file can be associated with greater storage requirements compared to maintaining only a single ladder per video file. There may be a trade off between the number of ladders that are to be maintained for a video file and storage costs so that a content delivery service level and utilization for end user devices is maintained to a certain threshold level defined for a content delivery system. For example, ladders that are not expected to be played in the future may be deleted to reduce the storage costs without reducing the performance of content delivered to end user devices associated with various network conditions and device configurations.

The present specification describes techniques for implementing a systematic process for identifying and removing content that is associated with low storage value to be maintained as unlikely to be requested by end user devices in the future (e.g., outdated content, content of specific characteristics that does not match end user device requirements or streaming patterns).

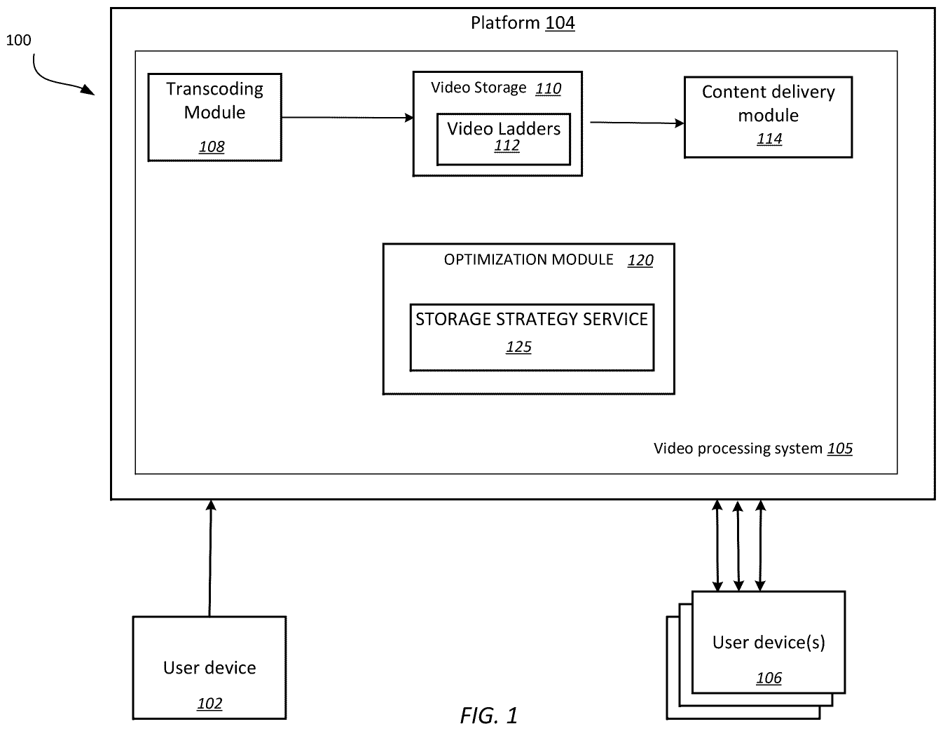

FIG. 1 shows a block diagram of an example video processing pipeline 100. The video processing pipeline 100 illustrates an example video processing by a platform 104, e.g., a social media platform, for delivery.

A user device 102 can provide a video to the platform 104. Videos can be received by user devices 106. The user devices can be any Internet-connected computing device, e.g., a laptop or desktop computer, a smartphone, or an electronic tablet. The user device can be connected to the Internet through a mobile network, through an Internet service provider (ISP), or otherwise.

Each user device can be configured with software, which will be referred to as a client or as client software, that in operation can access the platform 104 so that a user can interact with the platform 104. The client software can include a user interface supporting user interactions with the platform 104 including sending requests and receiving content. For example, the user can use the client software to upload video content to the platform 104 as well as receive videos from the platform 104. The client software can be a platform specific application installed on the user device, or can be a web-based application running in a browser.

In some implementations, the user interface of the client software can include a view for presenting a feed of videos, obtained from the platform 104 that the user can interact with. For example, the user can scroll up or down to switch between videos in the feed as well as interact with individual videos, e.g., by posting comments about the video, sharing the video, or expressing approval, e.g., liking the video.

In some implementations, the video content provided by the platform to user devices are short form videos. Short form videos are videos that are typically less than 90 seconds in length. In some implementations, short form videos have lengths of between 15 and 90 seconds. By contrast, long-form videos typically have lengths of at least 3 minutes. Short form videos can be defined according to specification and constraints defined for the platform 104 and have a length that is configured for the platform 104.

In the example video processing pipeline 100, the user device 102 obtains or creates a video. For example, the user device 102 can be a mobile device that generates the video using a camera of the mobile device. The user of the user device 102 can use the client software to upload the video to the platform 104, for example, to make the video content available for distribution to other users of the platform 104.

The platform 104 processes videos received from the user device 102 or otherwise obtained. The video processing can include various operations in addition to those described in this specification. For example, the video can be encoded with a particular encoding depending on the format of the received video. The content of the video can be analyzed, for example, to categorize the video or flag the video content as prohibited. For clarity, FIG. 1 is focused on a video processing system 105 of the platform 100 that transcodes and stores video content for delivery to user devices 106.

The video can be transcoded by a transcoding module 108. Video transcoding is a digital to digital conversion of one video encoding to another. In video streaming, transcoding allows for videos having different characteristics to be provided to user devices. For example, in low bandwidth network conditions, a lower resolution or lower bitrate version of the video can be provided to reduce potential stalling or buffering of the video while at higher bandwidth network conditions, higher resolution or bitrate versions can be provided. To provide these different versions of the video, the received video is transcoded by the transcoding module 108 into a number of different versions. The collected set of versions of the video are referred to as video ladders.

Transcoding can include processing the original input video, as provided by user device 102, to an intermediate uncompressed format and then encoding that version of the video into multiple encoding formats. A video can be transcoded into a set of versions, each version having particular resolution and bitrate characteristics. For example, an input video can be transcoded into the following video ladders:
4 k, 16 Mbps
2 k, 8 Mbps
1080p, 4.8 Mbps
1080p, 2.4 Mbps
480p, 900 Kbps
360p, 900 Kbps

Thus, a given resolution, e.g., as shown with 1080p, can include versions with different bitrates. Similarly, the same bitrates can be used for versions of different resolutions as illustrated by the 480p and 360p versions each having a 900 Kbps bitrate.

Once the video has been transcoded into multiple versions, the versions are stored as video ladders 112 in video storage 110. The video storage 110 may be a distributed storage among multiple storage devices. Further, the video storage 100 may be replicated in multiple locations such that multiple copies of the versions are stored, e.g., in multiple datacenters.

For new videos uploaded to the platform 104, the video storage 110 may make the ladder versions readily available for serving to user devices. A content delivery module 114, in response to an interaction with different end user devices 106, selects videos to provide to each user device 106 as well as the appropriate version from the corresponding video ladder 112. The selected version is then provided to the user device 106 for playback.

In some implementations, video processing system 105 may include other video processing, for example, compression of video data or re-encoding of input videos into a particular format.

In some implementations, the video storage 110 can be monitored and/or managed by an optimization module 120 that includes implemented logic to process data related to various video files stored at the video storage 110 and determine which video ladders 112 to maintain so that used storage space is reduced while service level and content delivery to user devices is maintained to meet user devices constraints, network connection requirements, and/or demand for content downloading or streaming. The optimization module 120 implements a systematic process of obtaining data for video files with respective video ladders stored at the video storage 110 and identifying actions to be performed for the various video files so that storage is used more efficiently (e.g., reduced storage space) and the content delivery is maintained adaptive to the streaming needs (e.g., playback of videos from a user's feed in the client software) of various end user devices in different network environments and having different hardware constraints. The optimization module 110 includes a storage strategy service 125 that can execute multiple storage strategies for a candidate set of video files that can be evaluated to identify video ladders from those video files that can be removed to reduce the storage space. The storage strategy service 125 can be used to identify video ladders that are to be deleted based on evaluating data associated with videos stored at the platform 104 and their viewing history (e.g., number of views, duration of views, file size, categories, etc.). For example, the optimization module 110 can obtain data for video files from the video storage 115 and input the data to the storage strategy service 125 to use trained models at the storage strategy service 125 to evaluate characteristics of the videos and estimate future viewing.

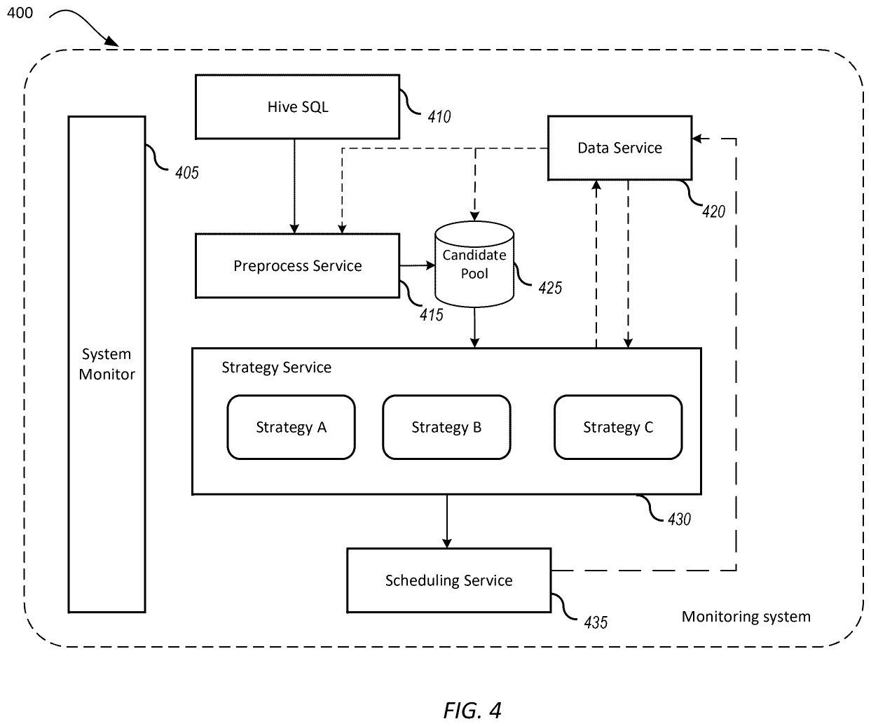

In some implementations, the optimization module 120 can be implemented as a monitoring system substantially similar to the monitoring system 400 of FIG. 4. In some instances, the strategy service 430 of the monitoring system 400 of FIG. 4 can correspond to the storage strategy service 125 of FIG. 1. In some implementations, the trained models at the storage strategy service 125 can output a video score for each video, where the output score value includes score values for maintaining each of the two or more video ladders as stored at the content delivery system for the first video files. In some cases, at least one video ladder is to be maintained per video file, so that streaming of that video content may be possible and available at all times even if only within a particular version. In some instances, based on monitoring of streaming video content, the number of video ladders per video file may be changed, for example, increased, and in that case a subsequent review for the video file and the storage of relevant ladders for that video file may be performed. For example, the subsequent review can be executed through the storage strategy service, for example, after a threshold period of time that had past since the latest evaluation of data for the file through the storage strategy service.

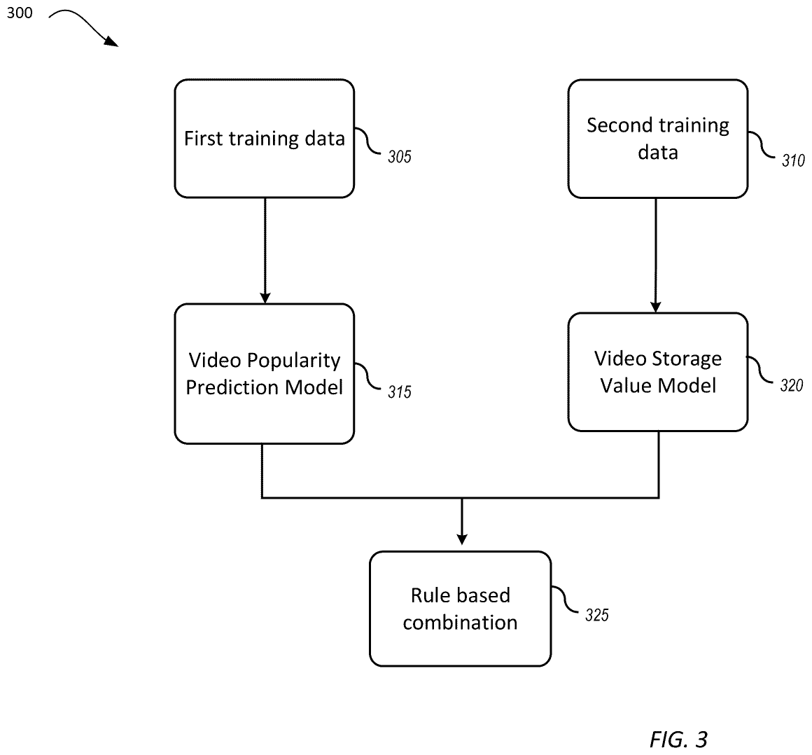

In some instances, the storage strategy service 125 can provide trained models that substantially correspond to the trained models described in relation to FIG. 3. Based on evaluation of the output video scores computed for each video and from each of the strategies, a determination for actions for one or more of the video files stored at the video storage 115 can be made. In some instances, based on such a determination, instructions to delete ladders for video files at the video storage 115 can be provided.

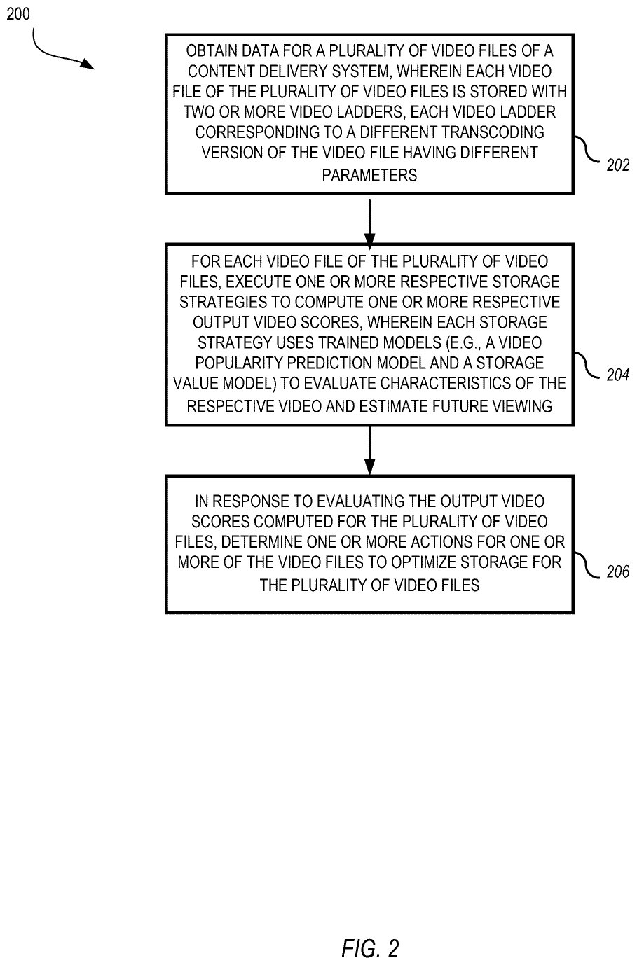

FIG. 2 is a flow diagram of an example process 200 for optimizing a video ladder storage. For convenience, the process 200 will be described as being performed by a system of one or more computers, located in one or more locations, and programmed appropriately in accordance with this specification. For example, a monitoring system, e.g., the optimization module 120 of FIG. 1, appropriately programmed, can perform the process 200.

The system obtains data for a collection of video files of a content delivery system (202). The content delivery system can store videos that can be received, for example, from a user device associated with a user account of the social media platform. For example, the user can generate the video content and upload it to the platform using the client software executing on the user device. Each video file of the collection of video files has a corresponding set of video ladders. Each video ladder can correspond to a different transcoding version of the video file having different parameters. In some instances, a video ladder can be considered as a version of a video having particular encoding parameters (e.g., a combination of bitrate and resolution). Each video ladder identifies a respective transcoding version of video content represented by a video file of the plurality of video file and has different parameters.

The system executes one or more respective storage strategies for each video file to compute one or more respective output video scores (204). One or more storage strategies can be determined as applicable for a given video file, where different video files can be determined to match with respective sets of storage strategies that may be matching (or overlapping), partially overlapping (e.g., having a common subset of strategies and associated with at least one strategy that is not appliable to the other file), or distinct strategies (or not overlapping). Multiple different storage strategies can be defined by a storage strategy service and the system can determine respective sets of strategies for each video file so that one or more output scores are determined for each video file and used to determine actions to be performed for the file. Each storage strategy uses trained models (e.g., as described in relation to FIG. 3) to evaluate characteristics of the respective video file and estimate future viewing.

The system determines one or more actions for one or more of the video files to optimize storage for the plurality of video files in response to evaluating the output video scores computed for the plurality of video files (206).

FIG. 3 is a block diagram of an example storage strategy service 300. The storage strategy service 300 can be implemented to process data for a selected set of video files that corresponds to a set of video ladders at a content delivery system. For example, the storage service 300 can be substantially the same as the storage strategy service 125 at the platform 104 of FIG. 1. The storage strategy service 300 can be executed to process data related to video content at the content delivery system and to compute video scores to be used to determine actions related to at least one of the video files. The determined actions can be executed at the content delivery system to reduce the storage requirements for the video files without reducing the utilization of content delivery methods to user devices having different device requirements and network connection restrictions.

The storage strategy service 300 provides trained models that evaluate characteristics of a respective video and estimate future viewing to output vide scores. The storage strategy service 300 can support the execution of multiple storage strategies where each storage strategy can include two trained models to determine a predicted viewing mode and a video storage value according to criteria of the respective strategy. Output video scores for a video can be evaluated according to a defined rule set.

In some instances, machine-learning models implemented as part of the storage strategy service 300 can be trained to provide output to support a determination for effective allocation of storage space to reduce costs. The trained models can include models that can predict a future number of views for a given video file or a duration of expected viewing of the video file within a period of time (e.g., n number of days such as 7, 14, 30 days). A video popularity prediction model 315 can be trained based on video data including information about the video file such as users that are following the account that had published the video file (also known as fans or followers).

The video popularity prediction model 315 can be trained to predict a future number of views or duration of viewing based on first training data (305) that is historical data associated with past viewing behavior including number of views and duration of viewing of videos selected for the training. Based on input data for a given video file, the video popularity prediction model can output a predicted viewing mode for the video file based on a predicted duration of viewing of the first video file or a predicted number of views within a particular period of time. The predicted viewing mode is indicative of a relative value of popularity of the two or more video ladders associated with the video file.

The video popularity prediction model 315 can output prediction results for expected video popularity for a given video file. For example, the popularity of a video can be defined according to a scale from 0 to 100 points, where the popularity score for a video can be normalized based on considering the popularity according to factors such as comprehensive playback, download, and sharing. In some instances, the output popularity score from the video popularity prediction model 315 for a given video file can be categorized as falling within a sub-range of the scale for popularity. For example, multiple ranges can be defined within the range of 0 to 10, where a first range of 0-30 can be defined to correspond to videos that are of lowest popularity, a second range of 30-60 can be defined to correspond to videos that are of mid-level popularity, and a third range 60 to 100 can be defined to correspond to videos that are considered to be with the highest popularity.

A video storage value model 320 can be trained to consider characteristics or attributes of the video files to determine a value score for maintaining ladders as stored for a given video file. The video storage value model 320 is trained based on second training data (310) including characteristics of video files defined for the training of the video storage value model, the characteristics being indicative of at least one of a video file category, duration, status, types of video ladders, and video file size. Based on input data for the video file, the video storage value model 320 can output a video storage value according to video characteristics of the first video file and two or more video ladders stored for the video file. The video storage value determined for the first video file is indicative of a relative value of storage of the two or more video ladders associated with the video file.

The video storage value model provides a storage value score for each video ladder (e.g., h264-720p 50, h264-540p 30, h264-1080p 70). The storage value score can be normalized to a value within the range of 0 to 100 based on the size of the video file and an image quality of the video content. The outputs from the video popularity prediction model 315 and the video storage value model 320 are provided for a given video file. The output can be combined (325) to compute a first output video score for the first video file according to the first storage strategy based on (i) the predicted duration of viewing of the first video file or the predicted number of views within the particular period of time and (ii) the determined video storage value. A rule-based combination can be applied to combine two scores to provide an output that can be indicative for the management of the storage of video ladders associated with the video file. For example, if a video is not popular, e.g., the video is associated with a popularity score below 30, half of the video ladders that are with the lowest parameters can be deleted, for example, video ladders including the h264-540p file and h264-720p file can be determined to be deleted. If a video is considered to be with a mid-level popularity based on a popularity score that is, e.g., between 30 to 60, only one video ladder can be defined to be deleted, for example, the video ladder from the set of stored ladders that is with the lowest parameters such as h264-540p file. If a video is popular and for example is considered to be with the highest popularity, it may be determined that no video ladders are to be deleted.

In some instances, the outputs from the video popularity prediction model 315 and the video storage value model 320 can be assigned with weight values (e.g., priority values indicative of relevance or importance of the given model and/or a particular video ladder within the combined score) to compute a weighted combination of the outputs. In some instances, the outputs from the models 315 and 320 may include an array of score values (or other data structure to store and present the scores) per video ladder (version) associated with the given video file. Combining the outputs can include computing a product value based on multiplying the output scores per video ladder by each strategy as determined for the given video file. In some instances, one video file can be evaluated based on a first set of strategies, and another video file can be evaluated based on another set of strategies, where the first and second sets of strategies may be the same, partially overlapping, or completely distinct. In some instances, different popularity strategies can be defined based on considerations for different categories of the video files. In those instances, the rule combination can be defined per category of the video files, where different actions can be determined to be performed for video files according to different or substantially similar ranges for output scores.

Different rules for combining output from different combinations of strategies (such as the first or second set of strategies) can be implemented. In some cases, the product value can be weighted product value, where weights can be determined per video ladder version and per model. For example, two weight values can be defined respectively for the output scores from the two models 315 and 325 for a first video ladder, where the two weight values can be different from other two weight values defined for the two output scores from the two models 315 and 320 for a second video ladder. As such, it may be possible that a particular video ladder is considered as more important for maintaining in the storage and thus a higher weight may be provided for the output scores for that video ladder.

In some implementations, the outputs from the video popularity prediction model 315 and the video storage value model 320 as provided for a given video file can be combined to determine an array of output scores per video ladder, where a score for a given video ladder is determined as a selection of a first score output by the model 315 or a second score output by the model 320. The selection can be predefined and based on implemented priority result controls or other score evaluation and comparison with a threshold value to perform a selection. In some cases, if conflicts between the output values per video ladder occur, a conflict resolution schema can be implemented with result control triggers that can support generation of an output, for example, by including further considerations and/or data to compute the output.

FIG. 4 is a block diagram of an example monitoring system 400 implementing machine learning techniques for optimization of storage for video files corresponding to multiple different ladders. Each video ladder can identify a respective transcoding version of video content (e.g., 540p, 720p) represented by a video file of the plurality of video file and has different parameters. Each video file with the corresponding video ladders can be stored at the content delivery system together with metadata that includes characteristics for the respective video file and/or video content. For example, the metadata can store information related to the category of video content, the type of the video, the size of the video file, the number of downloads of the video file, the time period for previewing the video file, account information of the user at the content delivery platform that uploaded the file, or other accounts associated with the video content (e.g., tagged, mentioned, commented, voted, etc.), among other types of metadata.

The monitoring system 400 can be part of the a content delivery platform, such as the platform 104, or can be executed as an external system that can obtain data for video files stored at the content delivery platform and provide instructions for optimization of the video storage to reduce storage costs without reducing the streaming performance and user utilization of the video playback provided to user devices connected to the content delivery platform.

The monitoring system 400 includes components such as the following.

A selection module (Hive SQL service) 410 that can execute requests to obtain data for videos from a video storage such as the video storage 110 of FIG. 1. The selection module 410 can select a video collection that is to be processed. For example, videos older than 90 days.

A preprocess service 415 can be used to perform pre-processing of the obtained data from the selection module 410. In some instances, pre-process service 415 can perform preprocessing of information for video files of the content delivery system to filter the video files and identify a candidate set of video files according to predefined filtering criteria. The predefined filtering criteria comprises rules for identifying a video file according to at least one of a video file status, a number of available ladders for the video file, and a timestamp of the video file.

In some instances, the preprocess service 415 can serve as a pre-processing filter to determine candidate videos for processing at a strategy service, for example, such as the storage strategy service 125 of FIG. 1. The preprocessing service 415 can filter and select videos from the content delivery system based on processing data for the videos. For example, the preprocessing service 415 can select videos for further evaluation by a strategy at the strategy service 430 based on video status and/or the availability of ladder positions, among other factors. For example, videos that have already undergone processing may be filtered out and not included in the candidate pool 425. In some examples, the preprocessing service 415 can perform video status filtering by performing checks of the status of each video, such as whether it has already been processed or if it meets predefined criteria for processing (e.g., videos of certain category may be excluded from processing, such as videos associated with content subject matter defined in a predefined list for the preprocessing service).

For example, if a video has been processed at the preprocessing service 415, the video can be marked and otherwise annotated as processed and may not be subsequently included in following iterations of data processing for videos stored at the content delivery system. In some instances, videos that are processed can be marked for a threshold period of time to not be included in subsequent processing, for example, a threshold number of hours, days, weeks, etc.

In some instances, the preprocess service 415 can include rules for filtering that consider the number of available ladders for a given video file. For example, before a video is included in the candidate pool, the video can be determined to have a number of available ladders, and if the number of available ladders is below a predefined threshold or if a specific ladder (e.g., 540p, 720p) is stored, that video file can be determined to be filtered out and not included in the candidate pool 425.

The candidate pool 425 retrieves information for video files that are not filtered out by the preprocessing service 415, as they are determined to be included in the candidate pool 425. The candidate pool 425 includes logic for obtaining data for the video files identified by the preprocess service and providing the obtained data to the strategy service 430 to compute output video scores, for example, as described in relation to FIGS. 1, 2, and 3. The candidate pool 425 can retrieve metrics and relevant data associated with a specific video feature for relevant videos that can be used for further processing, for example, at the strategy service 430.

The candidate pool 425 manages candidate video files that are identified as relevant for consideration by the strategy service 430, for example, based on a video file triggering different strategies' trigger events. When a trigger event occurs, such as a specific user action or system event, the candidate pool can identify the label tagged by the trigger service and can retrieve data associated with eligible candidate video files associated with the trigger event.

The strategy service 430 can be substantially similar to the storage strategy service 125 of FIG. 1. The strategy service can be configured to analyze input features related to a video and provide output scores that can be evaluated based on rules to define actions, such as whether to delete or move videos (with respective ladders) based on predetermined criteria of a respective strategy of multiple strategies defined in the strategy service 430. Each strategy at the strategy service can provide an output score value for a given video file, where the output scores can be evaluated by the scheduling service 435 to determine actions to be performed with respect to one or more video files and one or more video ladders stored for those files (e.g., delete a ladder). In some implementations, rules including mapping of output scores and correspondingly actions to be performed with regard to one or more of the video ladders of a video file can be defined. The rules can be dynamically maintained to correspond to system requirements and/or storage capacity at a given moment.

In some instances, the scheduling service 435 can include conflict resolution logic in cases where two strategies provide indications for performing actions that diverge significantly. In some instances, the determination of the difference (or divergence) between the actions that can be performed (e.g., as inferred from evaluating the output scores provided by executed strategies) can be performed according to a predefined schema and rules with thresholds to generate a final action list. In some instances, the scheduling service 435 can provide instructions for taking no actions with regard to stored video ladders, while also in some cases including an instruction to perform evaluation for the video file after a threshold period of time (e.g., after a day). In some cases, multiple threshold periods of time can be configured and the scheduling service 435 can determine which one to select to instruct subsequent evaluation of data for the video file depending on characteristics of the video file, provided output scores for the video file, or additional data related to other video files stored at the content delivery system. The strategy service leverages intelligent algorithms to assess video attributes and provide output that can be evaluated to determine storage management actions. The strategy service 430 includes trained models such as the described trained models in relation to FIG. 3.

In some examples, based on executing strategy A, it can be determined to delete two video ladders, L1 and L2, while based on executing strategy B for the same video file, it can be determined to retain ladder L1 and to delete ladder L3. Predefined rules can be defined for resolving such conflicts, where different strategies can be assigned different priorities and a determination of a strategy with a higher priority can be deterministic for the final output and instruction for the deletion and retention of ladders. For example, if strategy B has a higher priority, the ladder L1 is to be retained, and ladders L1 and L3 are to be deleted since this is the determination of the higher priority strategy.

The scheduling service 435 is configured to facilitate integration with existing storage management workflows or systems. The scheduling service 435 can provide output scores in a format that can be evaluated, for example, according to predefined rules and thresholds for determination of storage management actions. The actions determined by the scheduling service 435 can be provided as instructions to storage infrastructure or management tools, allowing for seamless execution of the recommended actions and actively managing the storage in a resource efficient manner.

The data service 420 includes logic to obtain and record data from executed strategies and to provide such data to the preprocessing service and the candidate pool when evaluating data for video files and identifying a candidate set of files to be processed for determining actions to reduce storage.

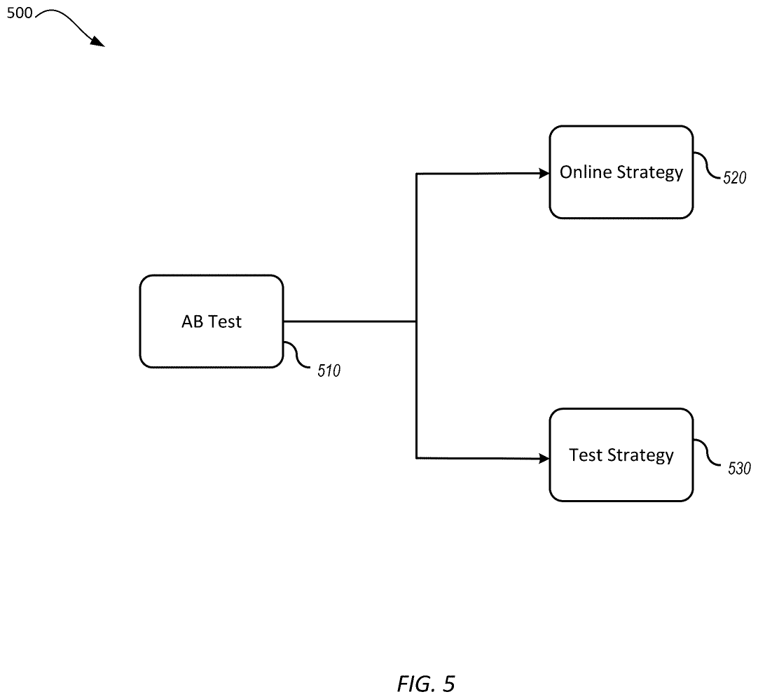

FIG. 5 is a flow diagram of an example process 500 for evaluation of performance of storage strategies.

Changes in video quality options can impact the user's playback experience. For example, if there are four ladders stored as different quality options/versions such as 1080p, 720p, 540p, and 480p, an optimization module, such as the optimization module 120 of FIG. 1 can execute respective storage strategies and can provide a determination to remove the 720p option. Such a removal of a ladder stored for a video file may result in a change in the overall viewing experience for users. For example, users who were able to watch videos at 720p due to their internet speed may now have to watch videos at 540p, leading to a decrease in video quality. In some examples, users who watch videos in 1080p may experience more buffering or stuttering due to the higher demand for their internet connection. To evaluate the impact of this strategy, at 510, an evaluation of the performance of the execution of a storage strategy can be evaluated by defining two groups of testing groups (group A and group B). The A group can serve as a control group, where for video files in that group, the stored video ladders are maintained (no actions to delete a ladder is applied), while the B group includes video files that for an experimental group including video files over which a given strategy to optimize (or reduce) storage is applied.

For a given video, the A group can include four video ladders as four quality options: 1080p, 720p, 540p, and 480p, whereas the B group can include only three options (one ladder is deleted): 1080p, 540p, and 480p. Playback experience-related metrics associated with users associated with group B can be monitored and evaluated during execution of the strategy in test mode at 530. The obtained metrics can be accessed for the impact of the applied strategy on the playback performance and user experience. If the metrics indicate that the impact on user playback experience is minimal (e.g., within a threshold range or below a threshold value of a scored performance experience), the strategy can be maintained and implemented as a live/online strategy at 520. In some instances, the experience-related metrics that can be used to evaluate a storage strategy can include average playtime of users and average buffering counts.

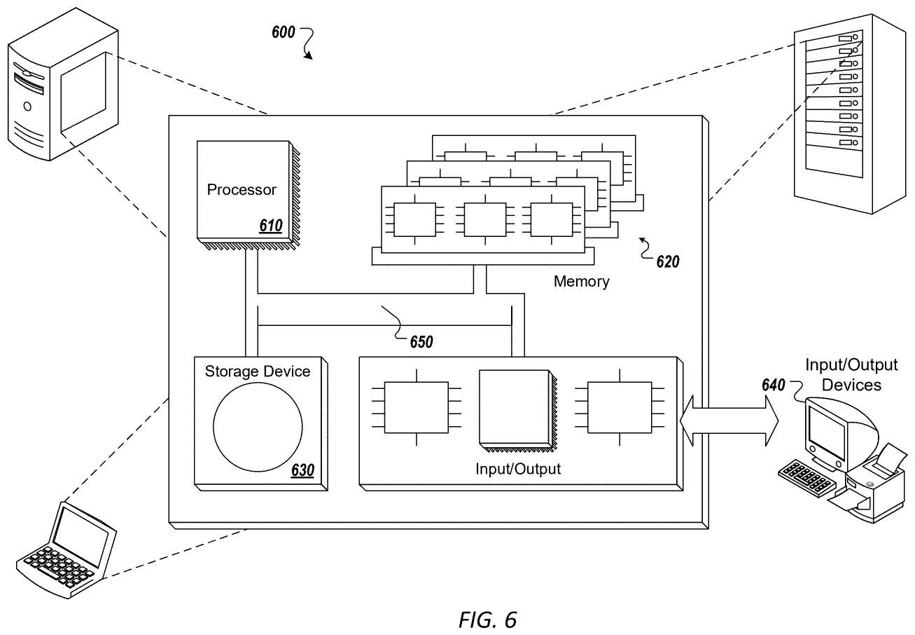

FIG. 6 is a flow diagram of an example process 600 for providing a video to a user device. For convenience, the process 600 will be described as being performed by a system of one or more computers, located in one or more locations, and programmed appropriately in accordance with this specification. For example, a content delivery system, e.g., the content delivery system 500 of FIG. 5, appropriately programmed, can perform the process 600.

The system receives a request for a video from a user device (602). The request can be received, for example, in response to a user interaction with software installed on the user device. For example, the user can execute a software application installed on the mobile device that is associated with a social media platform that is configured to provide video content. Executing the software can cause the software to request the content delivery system of the platform to provide one or more videos as part of a video feed. In another example, a user scrolling through a video feed presented on a user interface of the software can cause the system to select additional video content and that is then delivered to the user device by the content delivery system. While multiple videos may be requested and/or provided in a single interaction with the user device, for clarity the process 600 will focus on a single video. However, the system can perform a similar process for each video provided either individually or in batches.

It is important to note that the user device (or associated user) may not specify the video itself. Instead, the device can more generally request video content that is then specifically selected by the system. Thus, the request for the specific video may be determined by the system in response to a generalized request for content.

The system selects a ladder version of the video (604). The video may have one or more sets of ladders. For example, different sets of ladders may exist for different groups of users. In such scenarios, the system identifies which user group is associated with the request. The system then identifies a corresponding set of ladders for the video and, if applicable, the user group. The system then selects a particular ladder version from the set of ladders. The selection of a particular ladder version from the set of ladders can depend upon known information about the user device and/or associated user account. For example, the network capabilities between the platform and the user device can determine a suitable ladder version.

Additionally, user profile information indicating a preference of resolution over other factors such as stalling can influence the selection of the ladder version. For example, a user may explicitly indicate a preference of particular types of ladders, e.g., that emphasizes resolution or that minimizes lagging. In some implementations, the system selects the particular ladder version based on a combination of the ladder options, the network characteristics, and known or inferred user preferences.

The system provides the corresponding version of the video to the user device for playback (606). For a selected ladder version, there is a corresponding transcoded version of the video. The system retrieves the corresponding transcoded version of the video, e.g., from a suitable storage location, and provides that version to the user device. The software executing on the user device can then initiate playback of the video within a user interface of the user device.

In some implementations, the ladder version selected to provide to the user device for one video may be different for a next video not only because the set of ladders is specific to the video, but also because the network conditions may have changed between the platform and the user device.

FIG. 6 is a block diagram of a schematic diagram of an example computing system 600. The system 600 can be used for the operations described in association with the implementations described herein. For example, the system 600 may be included in any or all of the components of the content delivery system or video processing systems discussed in this specification. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 can be a volatile memory unit or a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a method, the method comprising:
obtaining data for a plurality of video files of a content delivery system, wherein the plurality of video files corresponds to a set of video ladders, each video ladder identifying a respective transcoding version of video content represented by a video file of the plurality of video file and having different parameters;
for each video file of the plurality of video files, executing one or more respective storage strategies to compute one or more respective output video scores, wherein each storage strategy uses trained models to evaluate characteristics of the respective video file and estimate future viewing of the video file; and
in response to evaluating the output video scores computed for each of the plurality of video files, determining one or more actions for one or more of the video files to reduce storage for the plurality of video files.

Embodiment 2 is the method of Embodiment 1, wherein executing the one or more respective strategies for each video file comprises:
selecting, for each video file, one or more respective storage strategies according to characteristics of the video file, wherein the one or more respective storage strategies are selected from a group of storage strategies defined for respective categories of video files; and
executing the selected one or more respective storage strategies for each video file to obtain one or more respective output video scores for each video file.

Embodiment 3 is the method of Embodiment 2, wherein executing a first respective storage strategy for a first video file comprises:
determining, based on a trained video popularity prediction model, a predicted viewing mode for the first video file based on a predicted duration of viewing of the first video file or a predicted number of views within a particular period of time;
determining, based on a trained storage value model, a video storage value according to video characteristics of the first video file and two or more video ladders stored for the first video file; and
computing a first output video score for the first video file according to the first storage strategy based on (i) the predicted duration of viewing of the first video file or the predicted number of views within the particular period of time and (ii) the determined video storage value.

Embodiment 4 is the method of Embodiment 3, wherein the trained video popularity prediction model is trained based on first historical data for a set of video files defined for the training, wherein the first historical data includes data for past number of views of the video files or a duration of viewing of the video files to determine the predicted viewing mode for the first video file for the particular period of time, wherein the predicted viewing mode is indicative of a relative value of popularity of the two or more video ladders associated with the first video file.

Embodiment 5 is the method of Embodiment 3 or Embodiment 4, wherein the video storage value model is trained based on second historical data including characteristics of video files defined for the training of the video storage value model, the characteristics being indicative of at least one of a video file category, duration, status, types of video ladders, and video file size, wherein the video storage value determined for the first video file is indicative of a relative value of storage of the two or more video ladders associated with the first video file.

Embodiment 6 is the method of any one of Embodiments 3 to 5, wherein determining one or more actions for the one or more of the video files comprises:
determining an action for the first video file to reduce storage based on evaluating the computed video score, wherein the action defines a video ladder of the two or more video ladders associated with the first video file to be deleted.

Embodiment 7 is the method of any one of the previous Embodiments, wherein evaluating the output video scores comprises:
combining one or more output scores computed for each video file of the plurality of video files based on executing one or more storage strategies for the video file.

Embodiment 8 is the method of any one of the previous Embodiments, wherein obtaining the data comprises:
pre-processing information for video files of the content delivery system to filter the video files to identify the plurality of video files according to predefined filtering criteria, wherein the predefined filtering criteria comprises rules for identifying a video file according to at least one of a video file status, a number of available ladders for the video file, and a timestamp of the video file.

Embodiment 9 is the method of any one of the previous Embodiments, wherein an output video score for a first video file of the plurality of video files includes score values for maintaining each of the two or more video ladders as stored at the content delivery system for the first video files.

Embodiment 10 is the method of anyone of the previous Embodiments, wherein determine one or more actions for the one or more of the video files comprises:
determining an action for a first video file to reduce storage at the content delivery system based on evaluating the output video scores computed for the plurality of video files according to the one or more respective storage strategies, wherein the action for the first video file is associated with a first video ladder stored for the first video file at the content delivery system, wherein the first video ladder is determined to be with a lowest value for maintaining at the content delivery system according to a rule threshold applied for evaluating output video scores for the first video file.

Embodiment 11 is a system comprising: one or more computers and one or more storage devices storing instructions that are operable, when executed by the one or more computers, to cause the one or more computers to perform the method of any one of embodiments 1 to 10.

Embodiment 12 is a computer storage medium encoded with a computer program, the program comprising instructions that are operable, when executed by data processing apparatus, to cause the data processing apparatus to perform the method of any one of embodiments 1 to 10.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining data for a plurality of video files of a content delivery system, wherein the plurality of video files corresponds to a set of video ladders, each video ladder identifying a respective transcoding version of video content represented by a video file of the plurality of video files and having different parameters;
for each video file of the plurality of video files, executing one or more respective storage strategies to compute one or more respective output video scores, wherein each storage strategy uses trained models to evaluate characteristics of a respective video file and estimate future viewing of the video file; and
in response to evaluating the output video scores computed for each of the plurality of video files, determining one or more actions for one or more of the video files to reduce storage for the plurality of video files.

2. The method of claim 1, wherein executing the one or more respective strategies for each video file comprises:
selecting, for each video file, one or more respective storage strategies according to characteristics of the video file, wherein the one or more respective storage strategies are selected from a group of storage strategies defined for respective categories of video files; and
executing the selected one or more respective storage strategies for each video file to obtain one or more respective output video scores for each video file.

3. The method of claim 2, wherein executing a first respective storage strategy for a first video file comprises:
determining, based on a trained video popularity prediction model, a predicted viewing mode for the first video file based on a predicted duration of viewing of the first video file or a predicted number of views within a particular period of time;
determining, based on a trained storage value model, a video storage value according to video characteristics of the first video file and two or more video ladders stored for the first video file; and
computing a first output video score for the first video file according to the first storage strategy based on (i) the predicted duration of viewing of the first video file or the predicted number of views within the particular period of time and (ii) the determined video storage value.

4. The method of claim 3, wherein the trained video popularity prediction model is trained based on first historical data for a set of video files defined for the training, wherein the first historical data includes data for past number of views of the video files or a duration of viewing of the video files to determine the predicted viewing mode for the first video file for the particular period of time, wherein the predicted viewing mode is indicative of a relative value of popularity of the two or more video ladders associated with the first video file.

5. The method of claim 3, wherein the video storage value model is trained based on second historical data including characteristics of video files defined for the training of the video storage value model, the characteristics being indicative of at least one of a video file category, duration, status, types of video ladders, and video file size, wherein the video storage value determined for the first video file is indicative of a relative value of storage of the two or more video ladders associated with the first video file.

6. The method of claim 3, wherein determining one or more actions for the one or more of the video files comprises:
determining an action for the first video file to reduce storage based on evaluating the computed video score, wherein the action defines a video ladder of the two or more video ladders associated with the first video file to be deleted.

7. The method of claim 1, wherein evaluating the output video scores comprises:
combining one or more output scores computed for each video file of the plurality of video files based on executing one or more storage strategies for the video file.

8. The method of claim 1, wherein obtaining the data comprises:
pre-processing information for video files of the content delivery system to filter the video files to identify the plurality of video files according to predefined filtering criteria, wherein the predefined filtering criteria comprises rules for identifying a video file according to at least one of a video file status, a number of available ladders for the video file, and a timestamp of the video file.

9. The method of claim 1, wherein an output video score for a first video file of the plurality of video files includes score values for maintaining each of the set of video ladders as stored at the content delivery system for the first video files.

10. The method of claim 1, wherein determine one or more actions for the one or more of the video files comprises:
determining an action for a first video file to optimize storage at the content delivery system based on evaluating the output video scores computed for the plurality of video files according to the one or more respective storage strategies, wherein the action for the first video file is associated with a first video ladder stored for the first video file at the content delivery system, wherein the first video ladder is determined to be with a lowest value for maintaining at the content delivery system according to a rule threshold applied for evaluating output video scores for the first video file.

11. A system comprising:
one or more computers and one or more storage devices on which are stored instructions that are operable, when executed by the one or more computers, to cause the one or more computers to perform operations, comprising:
obtaining data for a plurality of video files of a content delivery system, wherein the plurality of video files corresponds to a set of video ladders, each video ladder identifying a respective transcoding version of video content represented by a video file of the plurality of video files and having different parameters;
for each video file of the plurality of video files, executing one or more respective storage strategies to compute one or more respective output video scores, wherein each storage strategy uses trained models to evaluate characteristics of a respective video file and estimate future viewing of the video file; and
in response to evaluating the output video scores computed for each of the plurality of video files, determining one or more actions for one or more of the video files to reduce storage for the plurality of video files.

12. The system of claim 11, wherein executing the one or more respective strategies for each video file comprises:
selecting, for each video file, one or more respective storage strategies according to characteristics of the video file, wherein the one or more respective storage strategies are selected from a group of storage strategies defined for respective categories of video files; and
executing the selected one or more respective storage strategies for each video file to obtain one or more respective output video scores for each video file.

13. The system of claim 12, wherein executing a first respective storage strategy for a first video file comprises:
determining, based on a trained video popularity prediction model, a predicted viewing mode for the first video file based on a predicted duration of viewing of the first video file or a predicted number of views within a particular period of time;
determining, based on a trained storage value model, a video storage value according to video characteristics of the first video file and two or more video ladders stored for the first video file; and
computing a first output video score for the first video file according to the first storage strategy based on (i) the predicted duration of viewing of the first video file or the predicted number of views within the particular period of time and (ii) the determined video storage value.

14. The system of claim 13, wherein the trained video popularity prediction model is trained based on first historical data for a set of video files defined for the training, wherein the first historical data includes data for past number of views of the video files or a duration of viewing of the video files to determine the predicted viewing mode for the first video file for the particular period of time, wherein the predicted viewing mode is indicative of a relative value of popularity of the two or more video ladders associated with the first video file.

15. The system of claim 13, wherein the video storage value model is trained based on second historical data including characteristics of video files defined for the training of the video storage value model, the characteristics being indicative of at least one of a video file category, duration, status, types of video ladders, and video file size, wherein the video storage value determined for the first video file is indicative of a relative value of storage of the two or more video ladders associated with the first video file.

16. The system of claim 13, wherein determining one or more actions for the one or more of the video files comprises:
determining an action for the first video file to reduce storage based on evaluating the computed video score, wherein the action defines a video ladder of the two or more video ladders associated with the first video file to be deleted.

17. The system of claim 11, wherein evaluating the output video scores comprises:
combining one or more output scores computed for each video file of the plurality of video files based on executing one or more storage strategies for the video file.

18. The system of claim 11, wherein obtaining the data comprises:
pre-processing information for video files of the content delivery system to filter the video files to identify the plurality of video files according to predefined filtering criteria, wherein the predefined filtering criteria comprises rules for identifying a video file according to at least one of a video file status, a number of available ladders for the video file, and a timestamp of the video file.

19. The system of claim 11, wherein an output video score for a first video file of the plurality of video files includes score values for maintaining each of the set of video ladders as stored at the content delivery system for the first video files.

20. One or more computer-readable storage media encoded with instructions that, when executed by one or more computers, cause the one or more computers to perform operations, comprising:
obtaining data for a plurality of video files of a content delivery system, wherein the plurality of video files corresponds to a set of video ladders, each video ladder identifying a respective transcoding version of video content represented by a video file of the plurality of video files and having different parameters;
for each video file of the plurality of video files, executing one or more respective storage strategies to compute one or more respective output video scores, wherein each storage strategy uses trained models to evaluate characteristics of a respective video file and estimate future viewing of the video file; and
in response to evaluating the output video scores computed for each of the plurality of video files, determining one or more actions for one or more of the video files to reduce storage for the plurality of video files.
